(19) United States
(12) Patent Application Publication
(10) Pub. No.: US 2010/0001987 A1
(43) Pub. Date: Jan. 7, 2010

(54) SOURCE DRIVING CIRCUIT, DISPLAYER AND CONTROL METHOD THEREOF

(75) Inventors: Wei-Jhih Lian, Taipei County (TW); Ya-Wen Shieh, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/366,651

(22) Filed: Feb. 6, 2009

(30) Foreign Application Priority Data
Jul. 7, 2008 (TW) 97125594

(51) Int. Cl. G09G 5/00

(52) U.S. Cl. 345/214

(57) ABSTRACT

A source driving circuit is suitable for a display panel. The source driving circuit of the present invention has a plurality of latches and a plurality of output buffers. Each of the latches is used for respectively receiving a data signal. In addition, all of the latches output the corresponding data signals at different time intervals according to a data output signal. After all of the latches have output the data signals to the corresponding output buffers, all output buffers transmit the data signals to the display panel synchronously.

### CROSS-REFERENCE TO RELATED APPLICATION

This application claims the priority benefit of Taiwan application serial no. 97125594, filed Jul. 7, 2008. The entirety of the above-mentioned patent application is hereby incorporated by reference herein and made a part of specification.

### BACKGROUND OF THE INVENTION

1. Field of the Invention

The present invention relates to a source driving technology of a display panel and more particularly, to a source driving technology of a display panel having non-synchronous operations.

2. Description of Related Art

FIG. 1 illustrates a block diagram of a conventional source driving circuit. Referring to FIG. 1, in general, a source driving circuit 110 is used to drive a display panel 140. The conventional source driving circuit 110 comprises a plurality of latches 112, 114, . . . , 11n, respectively used to receive a plurality of data signals DS and transmit the received data signals to corresponding output buffers 122, 124, . . . , 12n in sequence.

The conventional source driving circuit 110 temporarily stores the data signals DS in sequence in the latches 112, 114, . . . , 11n when receiving the data signals DS. During a rising edge period of a control signal LS, the latches 112, 114, . . . , 11n output the data synchronously to convert voltages of the data signals DS and transmit the data signals DS to the corresponding output buffers 122, 124, . . . , 12n. During a falling edge period of the control signal LS, the output buffers 122, 124, . . . , 12n synchronously send output to the display panel 140 for driving the display panel.

In a conventional technology, if the display panel 140 has an SXGA resolution, the source driving circuit 110 has to comprise six or more source driving ICs disposed with latches and output buffers thereon. During the rising edge period of the control signal LS, all of the latches have to output data to convert the voltages. The power consumption is considerably large. In addition, large ripples are generated at both the power terminal and the ground terminal of the source driving circuit 110, resulting in errors of judgment in the circuit logic and even other status errors of the control signals.

### SUMMARY OF THE INVENTION

The present invention provides a source driving circuit which may reduce ripple effects.

In addition, the present invention provides a driving circuit and method thereof for a display panel which may reduce power consumption when driving a display panel.

The present invention provides a source driving circuit suitable for a display panel. The source driving circuit of the present invention comprises a plurality of latches and a plurality of output buffers. Each of the latches respectively receives a data signal and outputs the data signal to the corresponding output buffer at different time intervals based on a data output signal. After all of the latches have transmitted the data signals to the corresponding output buffers, all of the output buffers may synchronously send the data signals to the display panel based on a data output signal.

In one embodiment of the present invention, the data output signal may be an external signal.

In addition, the present invention further comprises a plurality of shift registers which may respectively generate data output signals to the corresponding latches. Each of the shift registers may comprise a plurality of D flip-flops. Each D flip-flop may transmit a data input signal to the next D flip-flop and the corresponding latch based on a clock signal. When receiving the data input signal, each of the latches may receive the corresponding data signal. In addition, the data input signal output by the final D flip-flop may be sent to the corresponding latch as a data output signal so that the corresponding latch may output the received data signal.

From another aspect, the present invention provides a driving circuit of a display panel comprising a display panel, a gate driving circuit, and a source driving circuit. The gate driving circuit and the source driving circuit are used to respectively output scan signals and data signals to the display panel. In the present embodiment, the source driving circuit comprises a plurality of latches. Each of the latches respectively receives a data signal and output the data signal at different time intervals based on a data output signal.

From another aspect, the present invention provides a control method of a displayer comprising receiving a plurality of data signals. Some of the data signals are sent to a buffer in sequence at a first time interval and the other data signals are sent to the buffer in sequence at a second time interval. When all of the data signals are sent to the buffer, the data signals are synchronously sent to the display panel for driving the display panel.

Each of the latches outputs the received data signals at different time intervals. Therefore, the power consumption as well as the ripple effects generated at the time of driving the display panel may be effectively reduced.

To make the above and other objectives, features, and advantages of the present invention more comprehensible, preferred embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram of a conventional source driving circuit.

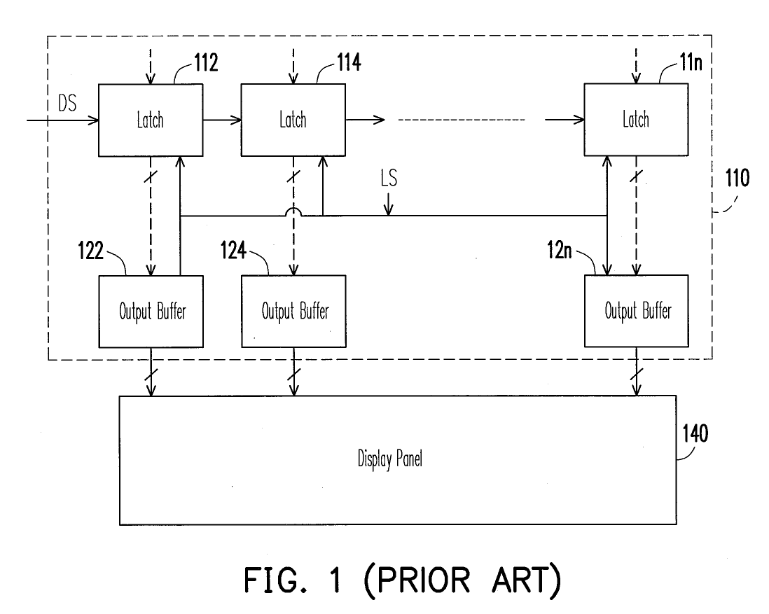

FIG. 2 is an internal block diagram of a displayer according to one embodiment of the present invention.

FIG. 3 is circuit block diagram of a source driving circuit according to a preferred embodiment of the present invention.

FIG. 4 is a timing diagram of the various signals in FIG. 3.

FIG. 5 is block diagram illustrating an internal structure of a shift register according to an embodiment of the present invention.

FIG. 6 is a flow chart showing the steps for controlling a displayer according to a preferred embodiment of the present invention.

### DESCRIPTION OF EMBODIMENTS

The following description illustrates the elements of the present invention accompanied with the figures in detail. Persons of ordinary skill in the art should know that the term “couple” in the descriptions below means that two objects are connected directly, through at least one element such as a resistor, a capacitor, or a conductive line, or through a signal transmission, which is not limited by the present invention herein and will not be illustrated unless specifically required.

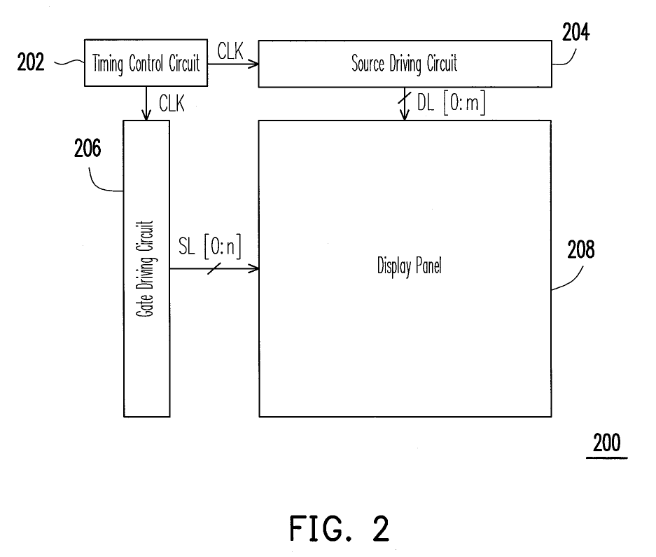

FIG. 2 is an internal block diagram of a displayer according to one embodiment of the present invention. Referring to FIG. 2, a displayer 200 may comprise a timing control circuit 202, a source driving circuit 204, a gate driving circuit 206, and a display panel 208. In the present embodiment, the display panel 208 may be an LCD panel, for example, and may be coupled to the source driving circuit 204 through m data lines DL and to the gate driving circuit 206 through n scan lines SL, wherein m and n are both positive integers. As such, the gate driving circuit 206 may transmit a scan signal to the display panel 208 through the scan lines SL[0:n] so as to respectively enable the pixels in the display panel 208 (not shown). In addition, the source driving circuit 204 may transmit the plurality of data signals to the display panel 208 through the data lines DL[0:m] so as to respectively drive each of the enabled pixels in the display panel 208.

Furthermore, in the displayer 200, the timing control circuit 202 is respectively coupled to the source driving circuit 204 and the gate driving circuit 206. Accordingly, the timing control circuit 202 may generate a clock signal CLK for the source driving circuit 204 and the gate driving circuit 206 so that they may respectively generate scan signals and data signals for the display panel 208.

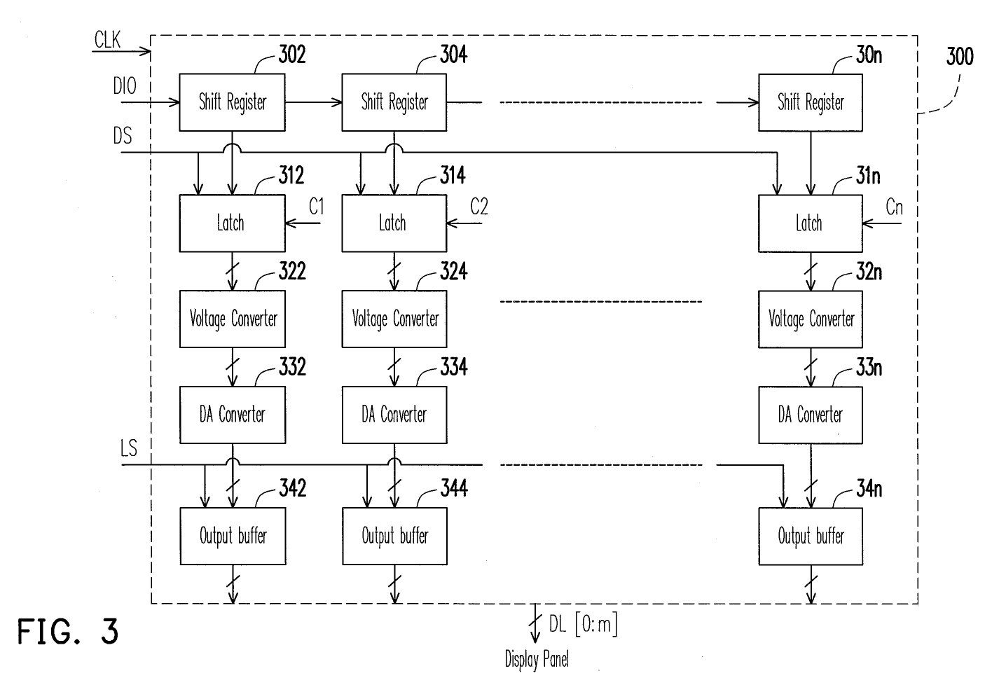

FIG. 3 is circuit block diagram of a source driving circuit according to a preferred embodiment of the present invention. Referring to FIG. 3, the present invention provides a source driving circuit 300 comprising a plurality of latches 312, 314, . . . , 31n, a plurality of voltage converters 322, 324, . . . , 32n, a plurality of DA converters 332, 334, . . . , 33n, and a plurality of output buffers 342, 344, . . . , 34n.

In the present embodiment, the source driving circuit 300 further comprises a plurality of shift registers 302, 304, . . . , 30n. The output of each of the shift registers 302, 304, . . . , 30n is coupled to the corresponding latches 312, 314, . . . , 31n and the input of the next shift register. The output of each of the latches 312, 314, . . . , 31n is coupled to the corresponding output buffers 342, 344, . . . , 34n through the corresponding voltage converters 322, 324, . . . , 32n and DA converters 332, 334, . . . , 33n. The first shift register 302 may receive a data input signal DIO and transfer the data input signal DIO in sequence to each shift register based on the clock signal CLK. When receiving the data input signal DIO from a previous shift register, the shift registers 302, 304, . . . , 30n may send the data input signal to the corresponding latches based on the clock signal CLK. Accordingly, when the latches 312, 314, . . . , 31n receive the data input signal DIO, the latches 312, 314, . . . , 31n may also receive data signals DS.

Each of the latches 312, 314, . . . , 31n comprises a plurality of temporary storage areas to store the received data signals DS. When the source driving circuit 300 receives the data signals DS, the first latch 312 may store the first of the data signals DS in the first temporary storage area, the second of the data signals DS in the second temporary storage area, and so on until all of the temporary storage areas in the latches 312, 314, . . . , 31n are filled.

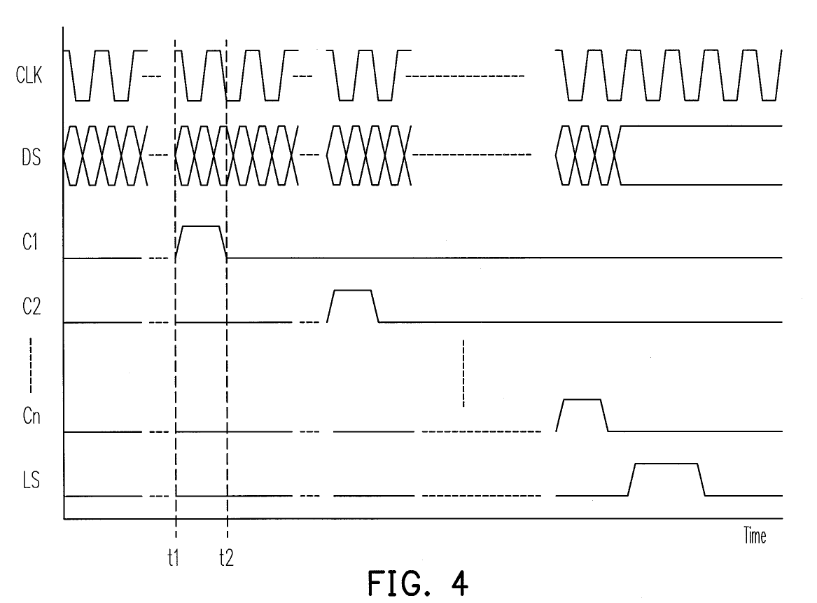

In particular, each of the latches 312, 314, . . . , 31n receives corresponding data output signals C1, C2, . . . , Cn and decides whether to output the data signals. FIG. 4 is a timing diagram of the various signals in FIG. 3. Referring to both FIG. 3 and FIG. 4, when the temporary storage areas of each of the latches 312, 314, . . . , 31n are all filled, the corresponding data output signals C1, C2, . . . , Cn may be enabled. At this time, the latches 312, 314, . . . , 31n may send the received data signals DS to the corresponding voltage converters 322, 324, . . . , 32n. However, in the present embodiment, the time intervals at which the data output signals C1, C2, . . . , Cn are enabled do not overlap. In other words, each of the latches outputs the received data signals DS at different time intervals. For example, at t1, the temporary storage areas in the latch 312 are all filled so the data output signal C1 is enabled. However, between time interval t1 and time interval t2, the latch 312 outputs the data signal DS to the voltage converter 322.

Clearly from FIG. 4, the time interval at which each data output signal is enabled is different. In other words, at a same time interval, at most one of the latches may output the data signal DS. That is, when the latches 312, 314, . . . , 31n output the data signals DS, it is not required for all of the voltage converters and DA converters to operate at the same time. Only the corresponding voltage converter and DA converter are required to operate and thus power will not be greatly consumed and the ripple effect may be eliminated.

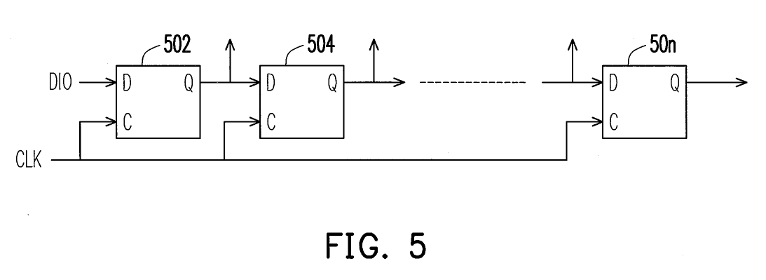

In the present embodiment, the data output signals C1, C2, . . . , Cn may be external data output signals or generated by the shift registers 302, 304, . . . , 30n. FIG. 5 is block diagram illustrating an internal structure of a shift register according to an embodiment of the present invention. Referring to FIG. 5, the shift registers comprise a plurality of D flip-flops 502, 504, . . . , 50n as the temporary storage areas. The output terminal Q of each of the flip-flops is coupled to the input terminal D of the next D flip-flop and outputs to the corresponding latches, for example, as the latches 312, 314, . . . , 31n shown in FIG. 3. In addition, each D flip-flop 502, 504, . . . , 50n comprises a clock signal terminal C to receive the clock signal CLK.

In FIG. 5, the input terminal D of the first D flip-flop 502 directly receives the data input signal DIO and transfer the data signal DS to the next D flip-lop 504. In particular, the data input signal DIO from the output terminal Q of the final D flip-flop 50n may be used as the data output signal C1, C2, . . . , Cn in FIG. 3. In other words, when the data signal DIO is transferred to the final D flip-flop 50n, at the next clock cycle, the D flip-flop 50n sends the output signal from the output terminal Q to the corresponding latch to make the latch output the data signal. Thus, the output signal from the final D flip-flop 50n may be a data output signal used to control whether the latches 312, 314, . . . , 31n in FIG. 3 output the data signals.

Continuously referring to FIG. 3, after the latches 312, 314, . . . , 31n respectively output the data signals DS to the voltage converters 322, 324, . . . , 32n, the voltage converters 322, 324, . . . , 32n convert the voltages of the data signals DS to an appropriate level and respectively output the data signals DS to the DA converters 332, 334, . . . , 33n to convert the data signals DS from a digital format to an analog format. Next, the DA converters 332, 334, . . . , 33n may respectively send the analog data signals DS to the output buffers 342, 344, . . . , 34n for temporary storage.

After all of the data signals DS are sent to the output buffers 342, 344, . . . , 34n, a control signal LS will be enabled, as shown in FIG. 4. At this time, the output buffers 342, 344, . . . , 34n, may synchronously send the data signals to the display panel through the data lines DL[0:m].

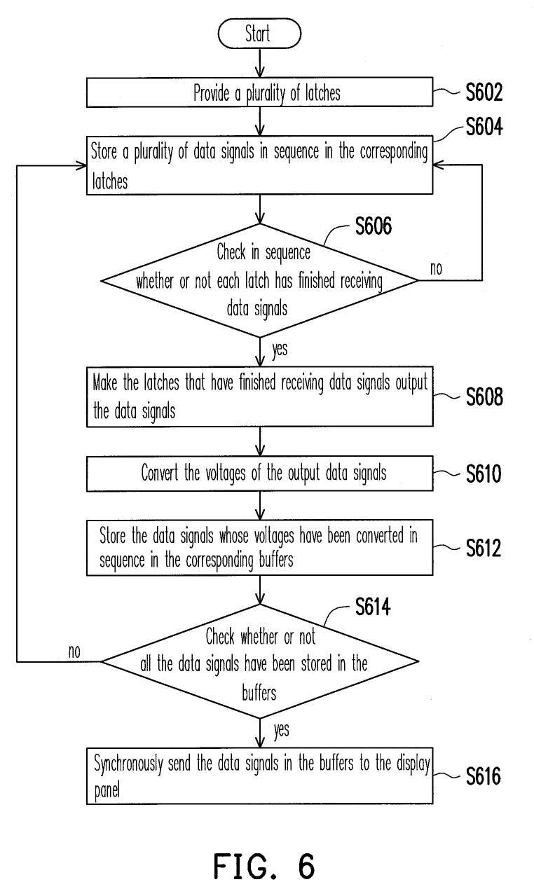

In summary of the above descriptions, the present invention further provides a control method of a display panel in FIG. 6. Referring to FIG. 6, in the present embodiment, a plurality of latches 302, 304, . . . , 30n as in FIG. 3, for example, are provided as described at step S602. In addition, a plurality of data signals are stored in the corresponding latches in sequence, as shown at step S604. At this time, step S606 may be carried out. That is, each latch is checked in sequence to confirm if all data signals have been received.

If the checked latch has not finished receiving the data signals (i.e. as indicated with “No” at step S606), step S604 is repeatedly carried out. If the checked latch has finished receiving the corresponding data signals (i.e. as indicated with “Yes” at step S606), step S608 is then carried out. That is, the latches that have received all the data signals output the data signals. Accordingly, some of the data signals may be output at a time interval and the other data signals may be output at another time interval. Furthermore, in some embodiments, the voltages of the data signals output from the latches may be converted as described at step S610. The data signals whose voltages have been converted may be stored in sequence in the corresponding buffers (e.g. the output buffers 342, 344, . . . , 34n in FIG. 3) as described at step S612.

At this time, a check is performed at step S614 to confirm if all of the data signals have been stored in the buffers. If there are still data signals that have not been stored in the temporary storage areas (i.e. as indicated at step S614 with “No”), step S604 is repeatedly carried out. On the contrary, if all of the data signals have been stored in the buffers (i.e. as indicated at step S614 with “Yes”), step S616 is then carried out. That is, the data signals that are temporarily stored in the buffers are synchronously sent to the display panel to display images to the user.

In summary, the registers may output data signals for voltage conversion and DA conversion at different time intervals. Therefore, power will not be greatly consumed at a same time interval. Accordingly, the present invention may also effectively reduce the influence of ripple effects.

Although the present invention has been disclosed by the above embodiments, they are not intended to limit the present invention. Those skilled in the art may make some modifications and alterations without departing from the spirit and scope of the present invention. Therefore, the protection range of the present invention falls in the appended claims.

What is claimed is:

1. A source driving circuit, suitable for a display panel, the source driving circuit comprising:
a plurality of latches, respectively receiving a data signal, wherein each of the latches further outputs a corresponding data signal at a different time interval based on a data output signal;
a plurality of voltage converters, respectively coupled to one of the latches to receive the data signals;
a plurality of DA converters, respectively coupled to an output terminal of one of the voltage converters; and
a plurality of output buffers, respectively coupled to output terminals of the DA converters to respectively receive the corresponding data signals,
wherein when all of the data signals output from the latches have been sent to the corresponding output buffers, the output buffers synchronously send the data signals to the display panel.

2. The source driving circuit according to claim 1, wherein the data output signals are external signals.

3. The source driving circuit according to claim 1, further comprising a plurality of shift registers used to respectively generate the data output signal to the corresponding latches.

4. The source driving circuit according to claim 1, wherein each of the shift registers comprises a plurality of D flip-flops, each of the D flip-flops transmits a data input signal to the next D flip-flop and the corresponding latch based on a clock signal, each of the latches receives the corresponding data signal when receiving the data input signal, and the data input signal output from the final D flip-flop may be sent to the corresponding latch as a data output signal.

5. A displayer, comprising:
a display panel;
a gate driving circuit, used to output a scan signal sent to the display panel through a plurality of scan lines; and
a source driving circuit, used to output a plurality of data signals sent to the display panel through a plurality of data lines, wherein the source driving circuit comprises:
a plurality of latches, respectively receiving a data signal, wherein each of the latches further outputs a corresponding data signal at a different time interval based on a data output signal;
a plurality of voltage converters, respectively coupled to an output terminal of one of the latches to convert the voltages of the data signals;
a plurality of DA converters, respectively coupled to an output terminal of one of the voltage converters to convert the data signals to analog signals; and
a plurality of output buffers, respectively coupled to outputs of the DA converters, wherein the output of each of the DA converters is respectively coupled to one of the data lines
and when all of the data signals output from the latches have been sent to the corresponding output buffers, the output buffers synchronously send the data signals to the display panel.

6. The displayer according to claim 5, wherein the data output signals are external signals.

7. The displayer according to claim 5, wherein the source driving circuit further comprises a plurality of shift registers respectively coupled to the latches and used to respectively generate the data output signals for the corresponding latches.

8. The displayer according to claim 7, wherein each of the shift registers comprises a plurality of D flip-flops, each of the D flip-flops transmits a data input signal to the next D flip-flop and the corresponding latch based on a clock signal, each of the latches receives the corresponding data signal when receiving the data input signal, and the data input signal output from the final D flip-flop may be sent to the corresponding latch as a data output signal.

9. The displayer according to claim 5, wherein the output buffers synchronously send the data signals to the display panel through the data lines after the latches have output all of the corresponding data signals.

10. The displayer according to claim 5, wherein the display panel is a liquid crystal display panel.

11. A control method of a displayer, suitable for controlling a display panel in the displayer, the control method comprising:
receiving a plurality of data signals;
sending a portion of the data signals in sequence to a buffer at a first time interval;
sending the rest of the data signals in sequence to the buffer at a second time interval;
sending the data signals to the display panel to drive the display panel synchronously when all of the data signals have been sent to the buffer.

12. The control method of a displayer according to claim 11, before sending the data signals to the buffers, further comprising:
converting the voltages of the data signals; and
converting the data signals from a digital format to an analog format.

13. The control method of a displayer according to claim 11, wherein the display panel is a liquid crystal display panel.
